(19) United States
(12) Patent Application Publication
(10) Pub. No.: US 2004/0040562 A1
(43) Pub. Date: Mar. 4, 2004

(54) Mask and spherically configured valve

(76) Inventor: Robert A. Brunell, Forestdale, MA (US)

Correspondence Address: BROMBERG & SUNSTEIN LLP, 125 SUMMER STREET, BOSTON, MA, 02110-1618, US

(21) Appl. No.: 10/229,935

(22) Filed: Aug. 28, 2002

(51) Int. Cl. A62B 18/08; A62B 18/02

(52) U.S. Cl. 128/206.15; 128/205.27; 128/206.12

(57) ABSTRACT

A valve includes a flexible member and a support member having a member connector. The flexible member is coupled with the member connector, which is substantially spherically configured.

### FIELD OF THE INVENTION

The invention generally relates to valves and, more particularly, the invention relates to valves used with filter masks.

### BACKGROUND OF THE INVENTION

Air filtration masks (referred to herein as “filter masks”) are widely used to protect people from air borne contaminants. For example, air borne dust particles are a commonly known hazard at a variety of different types of work sites. Consequently, workers at such sites often wear filter masks to avoid inhaling the potentially dangerous dust particles. To these ends, various types of filter masks are manufactured from a filtering material that filters contaminants from inhaled air. One problem with such filter masks, however, is that the filter material often creates an air resistance that can inhibit free breathing. To at least partially alleviate this problem, some filter masks include a one-way valve that permits its wearer to exhale more freely.

When the wearer is not exhaling, the valve should remain closed. In fact, this is preferred for all physical orientations of the mask. For example, if a flap valve is not normally biased closed by some force other than gravity, then it may open when the wearer bends over or otherwise causes the force of gravity to urge the flap away from its valve seat. Consequently, the filter mask may not provide the intended air filtering benefits.

The art has responded to this problem by providing filter masks with one-way valves that normally are biased closed in all physical orientations. One such valve includes a flexible flap that is specially molded to remain normally biased against its valve seat in all orientations. Although useful for its intended purpose, such a valve is relatively expensive to produce because it requires a specially molded flap. Other functionally similar configurations have been developed, but still are relatively complex, unreliable, and/or expensive to produce.

### SUMMARY OF THE INVENTION

In accordance with one aspect of the invention, a valve includes a flexible member and a support member having a member connector. The flexible member is coupled with the member connector, which is substantially spherically configured.

In some embodiments, the support member includes a valve seat and the flexible member is biased against the valve seat when in a closed mode to prevent fluid flow. The valve seat may have an effective center, and the member connector may be spaced from the effective center. Illustratively, the valve seat is in a single plane. Alternatively, the valve seat is in one or more planes, and the member connector is in a different plane than such one or more planes to normally maintain the flexible member against the valve seat.

The flexible member may be biased to be in a spherical configuration when in the closed mode. In some embodiments, the flexible member is manufactured to be normally flat when not connected to the member connector. The support member may include a substantially spherically configured rib having a radius substantially equal to that of the member connector. In still other embodiments, the support member also includes a valve seat that is connected to the member connector. The valve seat, member connector, and flexible member together form a void when in the closed mode.

In accordance with another aspect of the invention, a valve having a closed mode for preventing fluid flow and an open mode for permitting fluid flow includes a normally flat flexible member and a support member having a valve seat and member connector. The flexible member is coupled with the member connector and biased to be substantially spherically configured when in the closed mode.

### BRIEF DESCRIPTION OF THE DRAWINGS

The foregoing and advantages of the invention will be appreciated more fully from the following further description thereof with reference to the accompanying drawings wherein:

FIG. 1 schematically shows a filter mask manufactured in accordance with illustrative embodiments of the invention.

FIG. 2A schematically shows an isometric view of a valve configured in accordance with illustrative embodiments of the invention, where the valve is in a closed mode.

FIG. 2B schematically shows an isometric view of the valve shown in FIG. 2A where the valve is in an open mode.

FIG. 3 schematically shows an exploded view of the valve shown in FIG. 2A.

FIG. 4 schematically shows a plan view of a support member with coupled flap of the valve shown in FIG. 2A.

FIG. 5 schematically shows a cross-section of the support member and flap shown in FIG. 4 along line 5-5.

FIG. 6 schematically shows a cross-section of the support member and flap shown in FIG. 4 along line 6-6.

### DESCRIPTION OF ILLUSTRATIVE EMBODIMENTS

In illustrative embodiments of the invention, a filter mask is manufactured with a spherically configured valve, which, during normal use, should remain closed in all orientations when its user is not exhaling. To that end, the valve has internal components that normally bias a sealing flap in a spherical configuration when the valve is closed. Details of illustrative embodiments are discussed below.

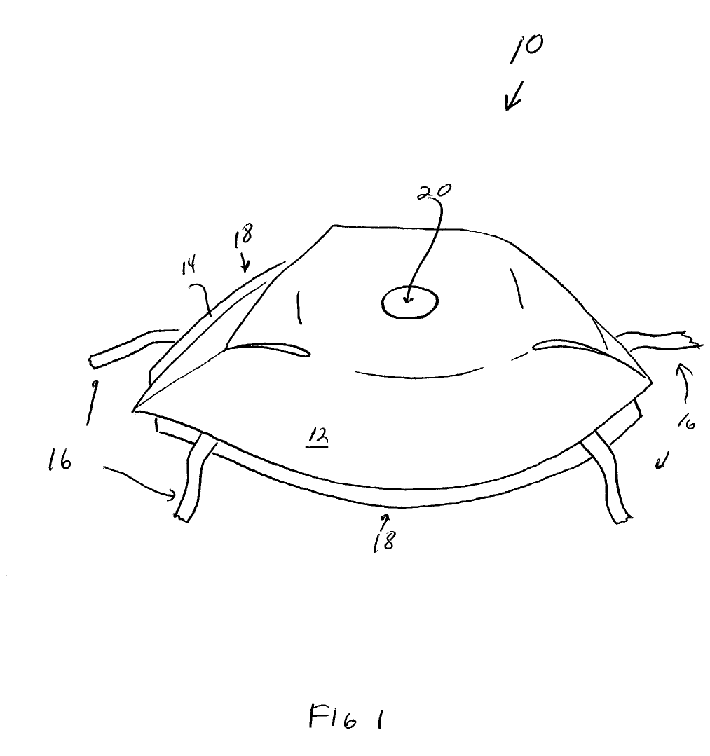

FIG. 1 schematically shows an exemplary filter mask 10 constructed in accordance with illustrative embodiments of the invention. The mask 10 may be similar to that disclosed in co-pending provisional U.S. patent application Ser. No. 60/386,297, having the title, “FACE MASK AND METHOD OF MANUFACTURING THE SAME,” filed on Jun. 5,2002, and naming Robert A. Brunell and George A. Snow and as joint inventors. The disclosure of that patent application is incorporated herein, in its entirety, by reference. Of course, it should be noted that although the mask 10 shown in that patent application and FIG. 1 are discussed, differently configured filter masks may be used in various embodiments of the invention.

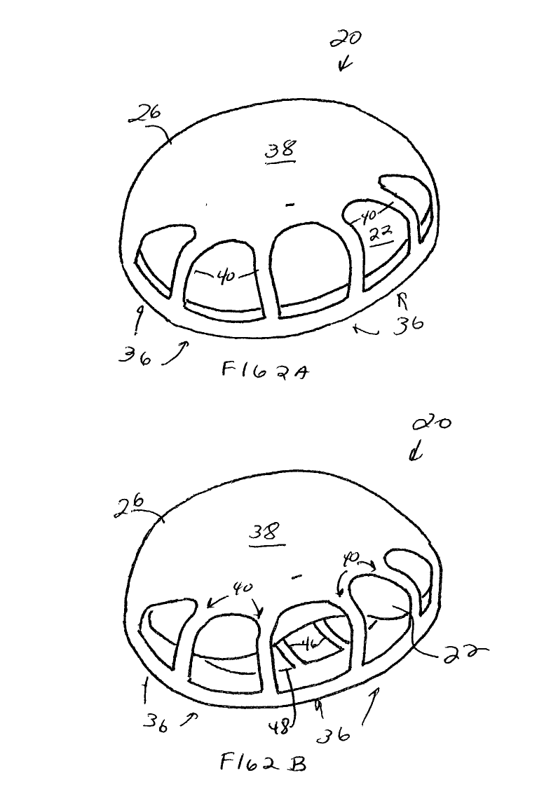

The filter mask 10 includes a filter layer 12 that is supported on a porous, but relatively more rigid, molded support base 14. In illustrative embodiments, the filter layer 12 and support base 14 are sufficiently resilient so that the filter mask 10 has a normally open concave area for sealingly receiving a user's nose and mouth. The filter mask 10 also includes a nose piece (not shown) to properly position the mask 10 against the user's nose, straps 16 to secure the mask 10 to the user's face, and a peripheral rim 18 that contours to the user's face when worn. The filter mask 10 also includes the above noted one-way valve 20, which more freely permits air to be exhaled. Details of the valve 20 are discussed below with reference to FIGS. 2A-6.

The straps 16 may be constructed from a resilient rubber material, or other conventionally known material (e.g., a non-resilient fabric), that permits a secure and snug fit between the user's face and the rim 18. The straps 16 thus apply an inwardly directed force for those purposes. At a minimum, this force should be sufficient at least to hold the mask 10 to the user's face. Moreover, it is preferred that the rim 18 have a contoured surface that contours to the user's face. Accordingly, when the straps 16 apply the noted inwardly directed force to the mask 10, the contoured surface should be sufficiently flexible and resilient to shape to the user's face. This ensures that the substantial majority of the user's air is inhaled and exhaled through the filter mask 10. In some embodiments, the rim 18 includes additional material (e.g., rubber) to provide an effective seal against the user's face.

FIG. 2A-6 show details of illustrative embodiments of the valve 20. In particular, with reference to FIGS. 2A and 2B, the valve 20 includes a rigid plastic housing containing a flexible member, referred to herein as “flap 22.” The Those skilled in the art sometimes refer to the flap 22 as a “diaphragm.” The interior of the housing is manufactured so that when the valve 20 is in a closed mode, the flap 22 is positioned to prevent air flow through the valve 20. Conversely, when the valve 20 is in an open mode, the flap 22 is positioned to permit air flow through the valve 20 in one direction. Consequently, movement of the flap 22 causes the valve 20 to transition between open and closed modes.

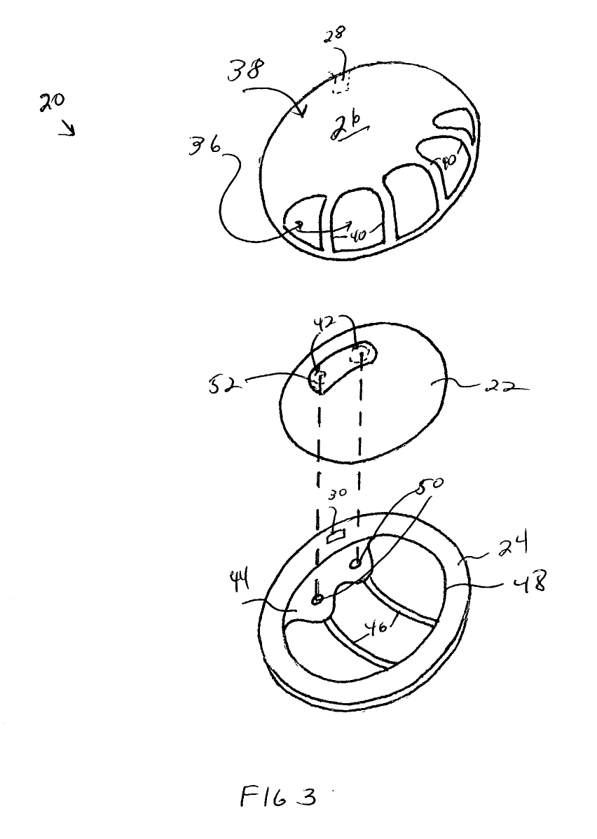

More specifically, as shown in the exploded view of FIG. 3, the valve 20 includes the above noted flap 22 and two housing portions 24 and 26. Namely, the housing portions 24 and 26 include a support member 24 for connecting to the flap 22, and a cover 26 for covering the flap 22. The cover 26 and support member 24 may be connected in any manner known in the art, such as with a snap-fit or ultrasonic welding. In illustrative embodiments, the cover 26 includes a tooth 28 that mates with a corresponding slot 30 in the support member 24 to align the two housing portions 24 and 26. In addition, the cover 26 may have a small protruding flange (not shown) around its periphery to snap into flexible mating ridges (not shown) on the support member 24.

The cover 26 has an open portion 36 to freely permit air flow, and a covered portion 38. The open portion 36 includes a plurality of fingers 40 that extend from the covered portion 38 to the periphery of the cover 26. The covered portion 38 may include a logo or other indicia indicating the make or type of mask 10. In alternative embodiments, the cover 26 does not include the covered portion 38. Specifically, in such embodiments, the substantial majority of the cover 26 may be open to freely permit fluid flow.

The flap 22 illustratively is produced from a flexible material that normally is substantially flat. In illustrative embodiments, the material is conventional gum rubber. More specifically, in illustrative embodiments, conventional processes stamp the flap 22 from a sheet of gum rubber to be in a substantially circular shape. No specialized molding processes are necessary to control the degree of curvature of the flap 22. It should be noted that although a specific material has been discussed (i.e., gum rubber), its discussion is exemplary and not intended to limit the scope of the invention.

Accordingly, in a manner similar to the discussed sheet of gum rubber, the flap 22 normally is substantially flat when not coupled with the valve 20. The flap 22 also may include a pair of holes 42 for receiving an anchor 52 that couples the flap 22 with the support member 24. In alternative embodiments, the flap 22 may have an integrally molded anchor (not shown) to secure with corresponding coupling holes 50 in the support member 24.

The support member 24 is specifically manufactured to cause the flap 22 to be spherically configured when the valve 20 is in its closed mode. More particularly, the flap 22 is considered to be “spherically configured” when its surface has a radius of curvature that is substantially uniform in all directions. In other words, to be spherically configured, all points on the surface of the flap 22 have a substantially identical (but finite-i.e., not flat) radius of curvature. More generally, an element of the valve 20 is considered to be spherically configured when such element has a radius of curvature that is substantially uniform. Accordingly, to spherically configure the normally substantially flat flap 22, the support member 24 has spherically configured components. The flap 22 is mounted within the housing so that the spherically configured elements of the support member 24 cause the flap 22 to be spherically configured. The flap 22 thus may be considered to be normally spherically configured when within the valve 20.

To these ends, the support member 24 includes a spherically configured flap connector portion 44 for connecting with the flap 22, and a pair of spherically configured ribs 46 for providing structural support to the flap connector portion 44. The flap connector portion 44 has a relatively large radius of curvature that also causes the ultimate radius of curvature of the flap 22 to be relatively large. In addition, the support member 24 also includes a valve seat 48 that cooperates with the flap 22 to seal the valve 20. The valve seat 48 illustratively is in a single plane that is different than that of the flap connector portion 44. As shown below, positioning the valve seat 48 in a different plane than the flap connector portion 44 more effectively permits the flap 22 to be spherically configured. In illustrative embodiments, the ribs 46 also are spherically configured.

To secure the flap 22, the flap connector portion 44 has a pair of holes 50 formed therein to receive the anchor 52 for securing the flap 22. As noted above, the anchor 52 may be separate from the flap 22, or may be integral with the flap 22. When separate, the anchor 52 may be any conventional material used for such purposes, such as plastic or rubber. In addition, the anchor 52 is manufactured to provide an inwardly directed force that normally forces the flap 22 to be substantially flush against the flap connector portion 44. Specifically, when the flap 22 is forced inwardly, its outer periphery bears against the valve seat 48, while a portion of its surface is substantially flush against the connector portion 44. The flap 22 also may bear against the ribs 46. The combination of forces cooperate to cause the flap 22 to be spherically configured. As noted above, because it is spherically configured, the flap 22 should remain closed in all orientations when the mask user is not exhaling.

One important feature of illustrative embodiments is the fact that the flap 22 is connected to the flap connector portion 44 at a location that is off center relative to the entire valve 20. Specifically, the flap 22 is not connected to the flap connector portion 44 at its center or at its periphery. While still enabling some relative flap stiffness, this arrangement permits the cracking pressure (i.e., the minimum air pressure to open the valve 20) to be lower than if the same flap 22 were connected at the substantial center of the valve 20. In addition, in a manner different than if it were connected at its periphery, this arrangement also permits the entire 360 degrees of the flap 22 to lift from the valve seat 48 to permit air flow. It should be noted that principles of the noted off-center connection applies to other valves that are not necessarily circular. For example, for a valve that is not symmetrically shaped with an exact center, a connection spaced away from an effective center should provide similar results.

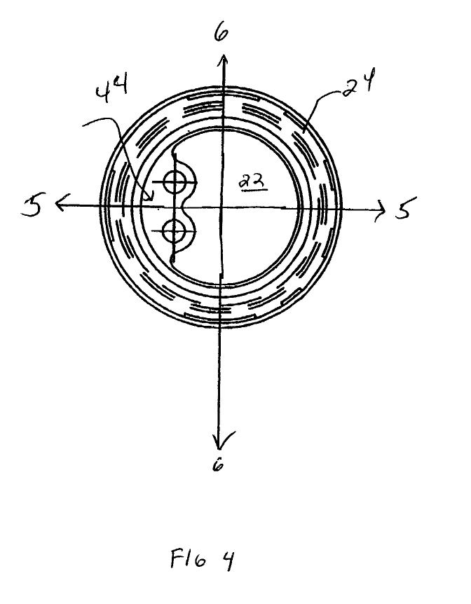

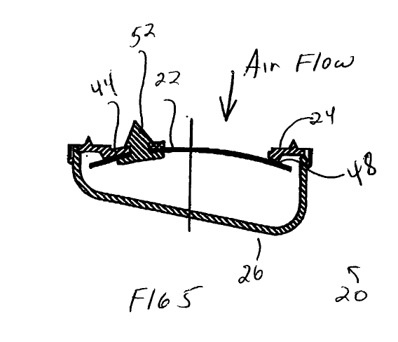

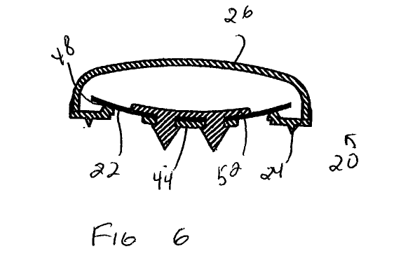

To illustrate the spherical configuration of various embodiments, FIGS. 5 and 6 respectively show cross sections of the valve 20 along lines 5-5 and 6-6 of FIG. 4. Although FIG. 4 shows the flap 22 and support member 24 only, FIGS. 5 and 6 are drawn to show the cross sections as if the cover 26 were attached to the support member 24. As shown, from both sides of the valve 20, the flap 22 is spherically configured and thus, remains flush against the valve 20 seat 48. A sufficient air flow in the direction indicated in FIG. 5 causes the flap 22 to lift from the valve seat 48, thus opening the valve 20. Air flow in the opposite direction thus is inhibited because the flap 22 cooperates with the valve seat 48 to prevent it from passing through the valve 20.

In some embodiments, the flap connector portion 44 does not smoothly merge into the valve seat 48. In such embodiment, the valve seat 48 forms an abrupt wall at the outer radial portion of the flap connector portion 44. The flap 22, valve seat 48 and flap connector portion 44 thus together form a small void at that point.

Although various exemplary embodiments of the invention have been disclosed, it should be apparent to those skilled in the art that various changes and modifications can be made that will achieve some of the advantages of the invention without departing from the true scope of the invention. These and other obvious modifications are intended to be covered by the appended claims.

What is claimed is:

1. A valve comprising:
a flexible member; and
a support member having a member connector,
the flexible member being coupled with the member connector, the member connector being substantially spherically configured.

2. The valve as defined by claim 1 wherein the support member includes a valve seat, the flexible member being biased against the valve seat when in the closed mode to prevent fluid flow.

3. The valve as defined by claim 2 wherein the valve seat has an effective center, the member connector being spaced from the effective center.

4. The valve as defined by claim 2 wherein the valve-seat is in a single plane.

5. The valve as defined by claim 2 wherein the valve seat is in one or more planes, the member connector being in a different plane than the one or more planes to normally maintain the flexible member against the valve seat.

6. The valve as defined by claim 1 wherein the flexible member is biased to be in a spherical configuration when in the closed mode.

7. The valve as defined by claim 1 wherein the flexible member is manufactured to be normally flat when not connected to the member connector.

8. The valve as defined by claim 1 wherein the support member includes a substantially spherically configured rib, the rib having a radius substantially equal to that of the member connector.

9. The valve as defined by claim 1 wherein the support member also includes a valve seat that is connected to the member connector, further wherein the valve seat, member connector, and flexible member form a void when in the closed mode.

10. A valve having a closed mode for preventing fluid flow and an open mode for permitting fluid flow, the valve comprising:
a normally flat flexible member; and
a support member having a valve seat and member connector,
the flexible member being coupled with the member connector and being biased against the valve seat and substantially spherically configured when in the closed mode.

11. The valve as defined by claim 10 wherein the valve seat has an effective center, the member connector being located between the valve seat and the effective center.

12. The valve as defined by claim 10 wherein the member connector is substantially spherically configured.

13. The valve as defined by claim 10 wherein the valve seat is substantially in a single plane.

14. The valve as defined by claim 10 wherein the support member includes a substantially spherically configured rib having radius substantially equal to that of the member connector.

15. The valve as defined by claim 10 wherein the flexible member is manufactured to be normally flat when not connected to the member connector.

16. A valve comprising:
a flexible member;
means for supporting the flexible member, the supporting means having means for contacting the flexible member, and means for connecting to the flexible member,
the connecting means including means for biasing the flexible member into a substantially spherical configuration.

17. The valve as defined by claim 16 wherein the connecting means is substantially in a spherical configuration.

18. The valve as defined by claim 16 wherein the contacting means cooperates with the flexible member to provide a seal.

19. The valve as defined by claim 16 wherein the contacting means has an effective center, the connecting means being between the effective center and the contacting means.

20. The valve as defined by claim 16 wherein the contacting means is a ridge within a single plane.

21. The valve as defined by claim 16 the flexible member is normally flat, the connecting means biasing the flexible member into the substantially spherical configuration when in the closed mode.

22. The valve as defined by claim 16 wherein the flexible member is urged out of its substantial spherical configuration when in the open mode.

23. The valve as defined by claim 16 wherein the flexible member has a circular shape.

24. A filter mask having a valve, the valve comprising:
a flexible member; and
a support member having a member connector,
the flexible member being coupled with the member connector, the member connector being substantially spherically configured.

25. The filter mask as defined by claim 24 wherein the support member includes a valve seat, the flexible member being biased against the valve seat when in the closed mode to prevent fluid flow.

26. The filter mask as defined by claim 25 wherein the valve seat has an effective center, the member connector being spaced from the effective center.

27. The filter mask as defined by claim 25 wherein the valve seat is in a single plane.
